(19) United States
(12) Patent Application Publication
(10) Pub. No.: US 2012/0258425 A1
(43) Pub. Date: Oct. 11, 2012

(54) APPARATUS FOR REMOVING ENAMEL OR DEBRIS FROM A TOOTH

(75) Inventor: Peter REK, Pura (CH)

(73) Assignee: SDC Switzerland SA, Montagnola (CH)

(21) Appl. No.: 13/080,083

(22) Filed: Apr. 5, 2011

(51) Int. Cl. A61C 17/00

(52) U.S. Cl. 433/142

(57) ABSTRACT

An apparatus for removing enamel or debris from a tooth includes a blade having an abrasive surface and a handle portion. The handle portion includes a support portion for mounting the blade and a shank having a proximal end connected to the support portion and a distal end. The shank includes a flexible shank portion having two flexible elements separated by a slit extending axially from the distal end of the shank along the flexible shank portion.

### TECHNICAL FIELD

The invention relates to the field of dentistry or orthodontics, and in particular relates to an apparatus for removing enamel or debris from a tooth.

### BACKGROUND

Apparatuses for removing enamel from a person's tooth are known in the field of dentistry or orthodontics. For example, they serve in removing enamel from one or more adjacently arranged teeth for the purpose of creating space, or additional space, between overcrowded teeth to avoid one or more tooth extractions. In other applications enamel is removed to enhance the shape and appearance of a tooth or of several teeth, for example for aesthetic reasons. In still further applications of such apparatuses debris like plaque or calculus can be removed from one or more teeth.

Many devices are known which are suitable to remove enamel both for the purpose of interproximal enamel reduction as well as for forming tooth-contours. These devices typically comprise a blade having an abrasive surface. To remove enamel, the blade is moved with its abrasive surface relative to the tooth with the abrasive surface being in contact with the enamel of the respective tooth or teeth. The blade is usually mounted to a handle portion. The handle portion can either be used to hold the blade by hand or can be connected to a driver mechanism. Such driver mechanisms normally generate a reciprocating movement which is transferred to the blade via the handle portion.

An apparatus for removing enamel from a person's tooth is known from U.S. Pat. No. 7,878,807 A1. The apparatus disclosed there comprises a blade having an abrasive surface which is adapted to remove enamel in response to reciprocatingly moving the abrasive surface against the enamel of the tooth. The blade is mounted to a handle portion comprising a shank which is to be inserted into a corresponding opening of a driver mechanism capable of reciprocatingly moving the shank and, consequently, the blade. The shank is force-fitted in a recess or opening of the driver mechanism. The force-fit of the shank in the recess or opening of the driver mechanism must be sufficiently strong to prevent the apparatus from getting released from the driver mechanism during the removal process. Due to this strong force-fit releasing the apparatus from the driver mechanism after completion of the removal process may be cumbersome.

Accordingly, it is an object of the invention to suggest an apparatus which overcomes the afore-mentioned problems of prior art apparatuses. In addition, the apparatus shall be easy to manufacture to allow production of an apparatus which is for single use only and which is disposed of after use. Also, from a constructional point of view the apparatus shall be suitable for the removal of debris such as plaque or calculus although in these cases a different blade may be used.

### SUMMARY OF THE INVENTION

The apparatus according to the present invention overcomes or at least greatly reduces the problems and disadvantages associated with the known apparatuses, in particular the apparatus according to the invention provides for an easy release of the shank of the handle portion from the driver mechanism.

In accordance with the invention, one embodiment of the apparatus for removing enamel or debris from a tooth includes handle portion and a blade having an abrasive surface. Generally, the abrasive surface can be of a structured metal or can be coated with hard materials like, for example the surface can be provided with a diamond coating. The handle portion comprises a support portion for mounting the blade. While it is generally conceivable that the blade can be mounted to the support portion with the aid of separate mechanical fasteners, it is preferred that the blade is mounted to the support portion in a molding process, in particular an injection molding process, in which the connection from the blade to the support portion is achieved through the moldable material flowing into openings or recesses provided at both ends of the blade. The handle portion further comprises a shank having a proximal end connected to the support portion and a distal end. The shank comprises a flexible shank portion having two flexible elements separated by a slit extending axially from the distal end of the shank along the flexible shank portion.

The flexible shank portion can be inserted into a through-opening of a driving mechanism with the distal end of the flexible shank portion being inserted first. In order to firmly connect the shank to the driving mechanism the shank can have a diameter which is slightly greater than the inner diameter of the through-opening of the driver mechanism. Upon insertion of the distal end of the flexible shank portion into the through-opening of the driver mechanism, the two flexible elements are compressed and further insertion of the flexible shank portion then leads to a press-fit in the through-opening with the distal end of the flexible shank portion projecting outwardly from the opposite end of the through opening. Enamel or debris can then be removed in the manner already described above, with the shank being firmly connected to the driver mechanism by means of the afore-described press-fit. To release the shank from the through-opening, it is possible to compress the two flexible elements at the distal end projecting outwardly from the opposite end of the through-opening, thus reducing the press-fit and allowing the apparatus to be removed from the driver mechanism. Advantageously, the shank may comprise at least one bulge running circumferentially around the shank. The at least one bulge can be formed along the entire circumference of the shank and may enhance the firm connection of the shank to the driver mechanism as will be explained in more detail below.

In accordance with a further advantageous aspect of the invention, the shank may comprise a first bulge and a second bulge axially spaced apart from one another along the shank. The first and second bulges are axially spaced apart from one another at a predetermined distance such that when the shank is inserted, the first bulge comes to lie in a complementary recess or groove in the inner wall defining the through-opening of the driving mechanism. The distance the second bulge is spaced apart from the first bulge is chosen such that when the first bulge comes to lie in the recess or groove in the inner wall, the second bulge abuts against an outer end face of the driver mechanism on that side of the through-opening from which the shank is inserted. Thus, in addition to the press-fit the two bulges further enhance the firm connection of the shank to the diver mechanism and provide for a protection of the shank against axial movement during the removal of enamel or debris, respectively. In accordance with a further aspect of the invention, the first bulge may be arranged in the flexible shank portion and the second bulge may be arranged between the proximal end and the flexible shank portion. During insertion of the shank the two flexible elements are compressed and the shank is then further inserted until the first bulge engages into the recess or groove and the second bulge abuts against the end face.

While the geometric shape of the first and second bulges is generally not limited to any certain geometry, in accordance with another aspect of the invention the first bulge has rounded edges and the second bulge has squared edges. The rounded edges allow the first bulge to be conveniently moved into the through-opening until the first bulge engages into the recess or groove. On the other hand, the squared edges define a clear-cut stop and provide an abutment surface preventing further insertion of the shank into the through-opening of the driver mechanism.

While generally not being limited to that shape, in accordance with a further aspect of the invention the shank may have a circular cross section. This allows to insert the shank at any desired and, as a consequence, the blade at any desired rotationally angular position relative to the driver mechanism so that depending on the location where the removal is to occur the blade can be arranged in the most favourable angular position.

In accordance with a further aspect of the invention, the shank may have a solid cross section between the proximal end of the shank and the flexible shank portion. In addition, the support portion may have a solid cross section, too.

In accordance with a still further aspect of the invention, the handle portion may be an integrally formed piece made of an injection moldable plastic (e.g. polyether ether ketone known as “PEEK” or materials sold under the trademark GRIVORY®, such as fibre-reinforced materials sold under the name GRIVORY® HT1V-5FWA black 9225, available from Ems-Chemie, EMS-CHEMIE AG, Business Unit EMS-GRIVORY, Via Innovativa 1, CH-7013 Domat/Ems, Switzerland) so as to simplify manufacture of the apparatus which can then be manufactured in a single manufacturing step. In accordance with a further aspect of the invention, the blade may have a thickness which is smaller than 1 mm. In particular, it may have a thickness within a range of 0.05 mm to 0.6 mm.

While some embodiments of the apparatus according to the invention the blade has no apertures, structure or sawteeth at all, in other embodiments of the apparatus according to the invention the blade may comprise apertures for transporting away the abraded enamel, or saliva, blood or other liquids, chemicals or pastes used in the treatment, or it may comprise sawteeth for generating space between two adjacent teeth or a ribbed surface for removing plaque or calculus, or combinations of apertures, sawteeth and ribs.

### BRIEF DESCRIPTION OF THE DRAWINGS

Embodiments of the invention are further described below with reference to the accompanying drawings for a more complete understanding of the present invention and advantages thereof.

FIG. 1 shows an example of an apparatus according to the invention;

FIG. 2 shows a top view of an embodiment of the shank of the apparatus according to the invention;

FIG. 3 shows an example of a head portion of a driving mechanism; and

FIG. 4 shows a further embodiment of an apparatus according to the invention.

### DESCRIPTION OF EXAMPLE EMBODIMENTS

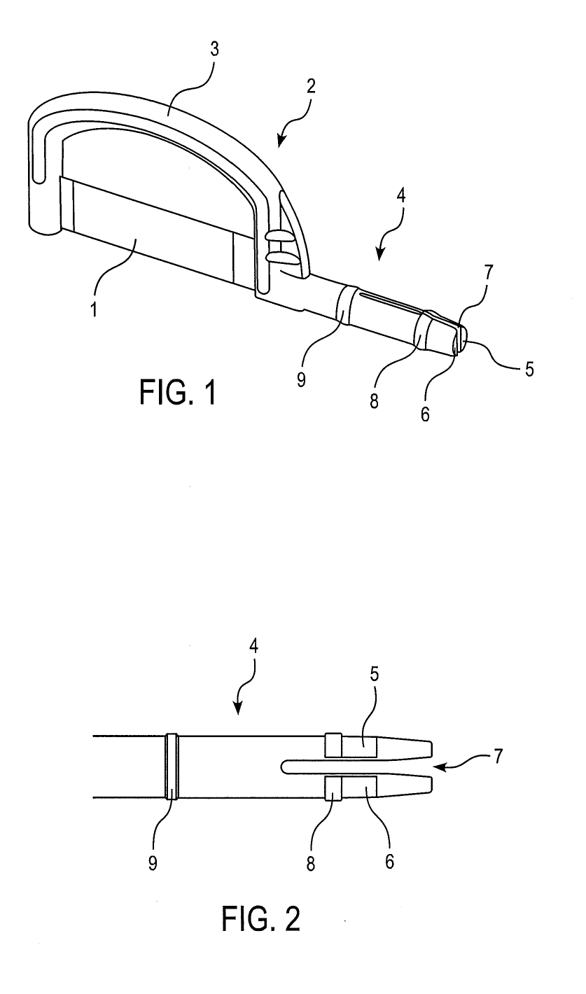

According to the invention as shown in FIG. 1, a first embodiment of an apparatus for removing enamel or debris from a tooth includes a blade 1 having an abrasive surface on at least one side of blade 1 or abrasive surfaces on both sides of blade 1. The apparatus further comprises a handle portion 2. Blade 1 is mounted to a support portion 3 of handle portion 2. Support portion 3 is bracket-shaped and comprises first and second bracket ends to which blade 1 is connected with its respective end portions. Blade 1 can be mounted to support portion 3 in a moulding process or, alternatively, it can be mounted to support portion 3 with separate mechanical fasteners (not shown). A shank 4 is integrally formed in one piece with support portion 3 with the proximal end of shank 4 being connected to one bracket end. Shank 4 comprises a flexible shank portion having two flexible elements 5,6 separated by a slit 7. Slit 7 extends axially from the distal end of shank 4 along the flexible shank portion and divides shank 4 into the afore-mentioned flexible elements 5,6. Shank 4 further comprises a first bulge 8 and a second bulge 9 running circumferentially around shank 4. To provide for a secure fit in a through-hole (or socket) of a driving mechanism first bulge 8 is arranged in the flexible shank portion while second bulge 9 is arranged between the proximal end of shank 4 and the flexible shank portion. This will be discussed in more detail below.

As can be seen again in FIG. 2, shank 4 has a flexible shank portion having first flexible element 5 and second flexible element 6 divided by slit 7. Slit 7 divides the flexible shank portion into the afore-mentioned two semi-circular flexible elements 5,6 which can be pressed together by a radial compression force. As can also be seen in FIG. 2, first flexible element 5 and second flexible element 6 both slightly taper towards the distal end of shank 4 for better insertion into a through-hole or socket of a driving mechanism. As is shown more clearly in FIG. 2, first bulge 8 is arranged in the flexible shank portion and second bulge 9 is arranged between the proximal end of shank 4 (not shown in FIG. 2) and the flexible shank portion. As can also be seen in FIG. 2, first bulge comprises rounded edges while second bulge 9 comprises squared edges (which may be slightly chamfered) to form a clear-cut stop having an abutment surface.

FIG. 3 shows an embodiment of a head portion 10 of a driver mechanism to which the apparatus according to the invention can be connected by means of the shank. Head portion 10 comprises a driveable socket 12 (e.g. a sleeve) for accommodating shank 4 of handle portion 3 of the apparatus according to the invention. Socket 12 is open at both ends so as to allow insertion of shank 4, in the shown embodiment shank 4 may be inserted from the left hand side. Socket 12 comprises a recess or groove (not shown) to accommodate first bulge 8 as the shank is inserted into socket 12 and moved further into socket 12 in the axial direction. First bulge 8 and second bulge 9 are arranged at an axial distance from one another, said axial distance being such that upon complete insertion into socket 12 first bulge 8 engages into the recess or groove while second bulge 9 abuts against an end face of head portion 10 (against the left hand end face of head portion 10 in FIG. 3). The distal end of shank 4 then projects outwardly from the opposite end of socket 12. The outer diameter of shank 4 (without bulges) is slightly greater than the inner diameter of socket 12 so as to achieve a compression fit. Once being mounted to the head portion 10 in the manner described the treatment of the tooth or teeth can be performed. For that reason, head portion 10 is capable of reciprocatingly driving socket 12 in the axial direction.

Once the treatment of the tooth or teeth has been completed, the apparatus according to the invention is removed from head portion 10 by pressing the two ends of first flexible element 5 and second flexible element 6 together, and by then pushing the apparatus in the axial direction out of socket 12 of head portion 10 of the driver mechanism (in FIG. 3 towards the left). In case the apparatus according to the invention is embodied as a single-use device, the used device can then be disposed of.

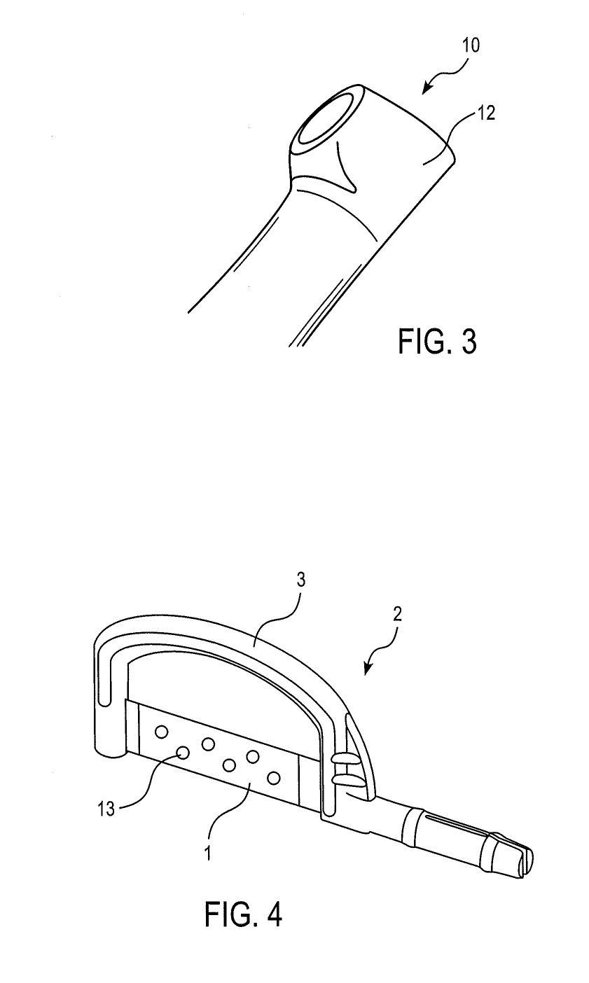

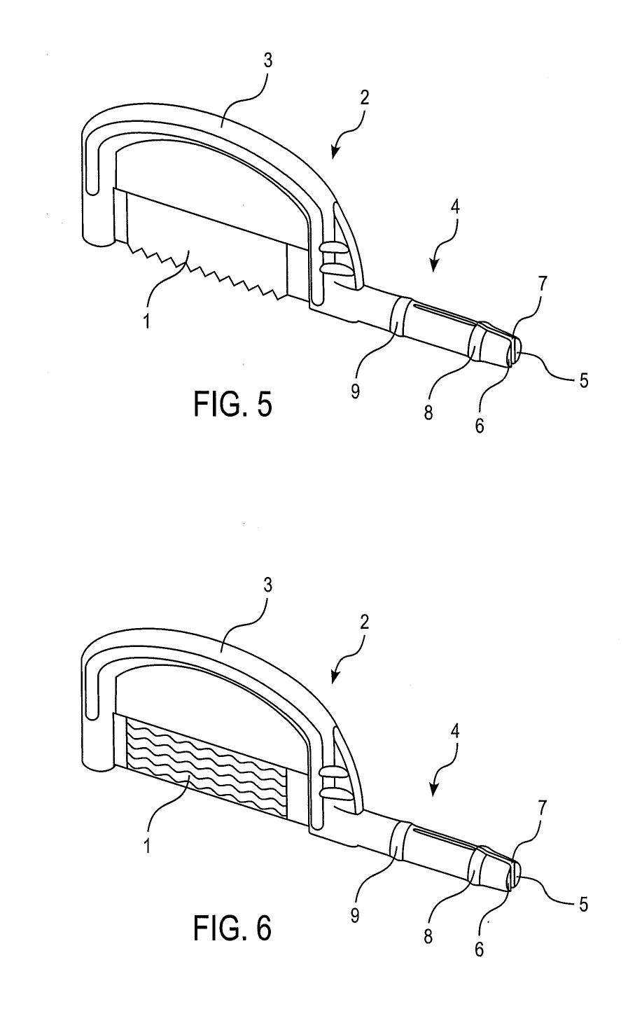

A further embodiment of the apparatus according to the invention is shown in FIG. 4. In this embodiment, blade 1 comprises apertures 13 for removing abraded enamel, or saliva, blood or other liquids, chemicals or pastes used in the treatment. While apertures 13 are shown by way of example, blade 1 may comprise sawteeth on its lower edge for generating space between two adjacent teeth, or it may comprise one or more ribbed surfaces for removing plaque or calculus on its side surfaces. Also, blade 1 may be embodied to comprise combinations of apertures, sawteeth and ribs.

While embodiments of the invention have been described many changes, substitutions, variations, alterations, transformations, and modifications are conceivable to one skilled in the art without departing from the spirit and scope of the present invention. Therefore, the embodiments are not intended to limit the invention, but rather the present invention is intended to encompass such changes, substitutions, variations, alterations, transformations, and modifications. Accordingly, the scope of the invention is defined by the appended claims.

1. An apparatus for removing enamel or debris from a tooth, the apparatus comprising:
a blade having an abrasive surface and having first and second end portions;
a handle portion,
wherein the handle portion comprises a support portion for mounting the blade, the support portion comprising first and second ends to which the first and second end portions of the blade are connected, and a shank having a proximal end connected to one of the first and second ends of the support portion and a distal end,
wherein the shank comprises a flexible shank portion having two flexible elements separated by a slit extending axially from the distal end of the shank along the flexible shank portion, and wherein the shank comprises a first bulge axially spaced apart from a second bulge along the shank, the first and second bulges running circumferentially around the shank.

2.-3. (canceled)

4. The apparatus of claim 1, wherein the first bulge is arranged in the flexible shank portion and the second bulge is arranged between the proximal end of the shank and the flexible shank portion.

5. The apparatus of claim 4, wherein the first bulge has rounded edges and the second bulge has squared edges.

6. The apparatus of claim 1, wherein the shank has a circular cross-section.

7. The apparatus of claim 1, wherein the shank has a solid cross section between the proximal end of the shank and the flexible shank portion.

8. The apparatus of claim 1, wherein the handle portion is an integrally formed piece made of an injection moldable plastic.

9. The apparatus of claim 1, wherein the blade has a thickness smaller than 1 mm, in particular within a range of 0.05 mm to 0.6 mm.

10. The apparatus of claim 1, wherein the blade comprises apertures, sawteeth or a ribbed surface, or combinations thereof.

11. The apparatus of claim 1, wherein the support portion is bracket-shaped.
